(19) United States
(12) Patent Application Publication
(10) Pub. No.: US 2011/0107344 A1
(43) Pub. Date: May 5, 2011

(54) MULTI-CORE APPARATUS AND LOAD BALANCING METHOD THEREOF

(75) Inventors: Kyoung Hoon KIM, Suwon-si (KR); Il Ho LEE, Suwon-si (KR); Joong Baik KIM, Seocho-gu (KR); Seung Wook LEE, Suwon-si (KR)

(73) Assignee: Samsung Electronics Co., Ltd., Suwon-si (KR)

(21) Appl. No.: 12/915,927

(22) Filed: Oct. 29, 2010

(30) Foreign Application Priority Data
Oct. 29, 2009 (KR) 10-2009-0103328

(51) Int. Cl. G06F 9/46

(52) U.S. Cl. 718/105

(57) ABSTRACT

A multi-core apparatus and method for balancing load in the multi-core apparatus. The multi-core apparatus includes a first core that sends a save request including a context of a task, when a task is switched from an active state to a sleep state, a second core that receives an execution request and executes a task corresponding to the execution request, and a load balancer that receives the save request transmitted by the first core, and sends the execution request to the second core.

### PRIORITY

This application claims priority under 35 U.S.C. §119(a) to a Korean Patent Application No. 10-2009-0103328, filed in the Korean Intellectual Property Office on Oct. 29, 2009, the entire disclosure of which is hereby incorporated by reference.

### BACKGROUND OF THE INVENTION

1. Field of the Invention

The present invention relates generally to a multi-core apparatus and, in particular, to a method for balancing load between the multiple cores of the multi-core apparatus.

2. Description of the Related Art

In recent embedded systems, multi-core based technologies are being used to overcome limitations of processing using a conventional signal core system.

In a multi-core system, a single task can be processed by multiple cores in sequential order. For example, a task can be alternately processed by a first core for the first 10 seconds and then by a second core for the next 10 seconds. However, data loaded on a cache of the first core becomes useless, and the second core has to wait for the data to be loaded on its cache from a relatively slow external memory device, resulting in processing delay.

Additionally, the multi-core system is in need of a separate Operating System (OS) that can substitute for the current conventional single core-dedicated OS. However, this type of OS development requires a large amount of cost and time, and still includes difficulty in security verification.

Further, when using virtualization, a large number of virtual cores required, e.g., equal to the square of a number of physical cores for the same performance, which wastes resources and degrades processing speed.

### SUMMARY OF THE INVENTION

The present invention is deigned in view of at least the above-described problems of the prior arts.

Accordingly, an aspect of the present invention provides a multi-core apparatus and load balancing method of a multi-core apparatus that is capable of efficiently balancing a load between multiple cores.

Another aspect of the present invention provides a multi-core apparatus and load balancing method of a multi-core apparatus that is capable of efficiently utilizing virtual cores.

Another aspect of the present invention provides a multi-core apparatus and load balancing method of a multi-core apparatus that is capable of reducing development costs of an operating system dedicated to a multi-core system.

In accordance with an aspect of the present invention, a first core that sends a save request including a context, when a task is switched from an active state to a sleep state, the context including information on a state of the task; a second core that receives an execution request and executes a task corresponding to a context included in the execution request; and a load balancer that receives the save request transmitted by the first core, saves the context included in the save request, assigns a saved context to the second core, and sends, to the second core, the execution request including the context assigned to the second core.

In accordance with another aspect of the present invention, a load balancing method of a multi-core apparatus includes receiving, from a first core, a save request, the save request including a context of a task that is switched from an active state to a sleep state; storing the context included in the save request; assigning a stored context to a second core; and transmitting, to the second core, an execution request including the context assigned to the second core.

### BRIEF DESCRIPTION OF THE DRAWINGS

The above and other aspects, features, and advantages of the present invention will be more apparent from the following detailed description in conjunction with the accompanying drawings, in which:

FIG. 1 is a diagram illustrating a multi-core apparatus according to an embodiment of the present invention;

FIG. 2 is a flowchart illustrating a load balancing method of a multi-core apparatus according to an embodiment of the present invention;

FIG. 3 is a flowchart illustrating a load balancing method of a multi-core apparatus according to another embodiment of the present invention;

FIG. 4 is a flowchart illustrating a load balancing method of a multi-core apparatus according to another embodiment of the present invention; and

FIG. 5 is a block diagram illustrating a multi-core system based on core virtualization according to an embodiment of the present invention.

### DETAILED DESCRIPTION OF EMBODIMENTS OF THE INVENTION

Various embodiments of the present invention are described in detail below with reference to the accompanying drawings. The same reference numbers are used throughout the drawings to refer to the same or like parts. Additionally, detailed descriptions of well-known functions and structures incorporated herein may be omitted to avoid obscuring the subject matter of the present invention.

In the following description, the term “task” refers a unit of work to be processed by a device.

Additionally, the term “context” denotes the progression information of a task. For example, when a task is paused, it can be restarted from the paused time point by referencing the recorded context. That is, the context may be the data needed to restart the paused task. The context of a task can also include a program counter of the task and memory management information, accounting information, register, task status, and input/output status information. The structure of context can be changed depending on the operating system and type or model of the system.

Further, the term “context switch” denotes switching the context of a core. Switching the context of a core means that a task is switched between cores. For example, if the context switch occurs while the core processes a task, the context of the current task is stored in a predetermined storage and the context of a new task is called to the core. A context switch can also occur when there is no task being processed (core in sleep state) or to be processed (current task being switched to another core). For example, an old task that is being processed by the current core is switched from active to sleep state and a new task is switched from sleep to active state.

The sleep state denotes a state in which no task is processed. However, a task that is in a sleep state at one core can be in active state at another core. In view of the core that stops processing a task, the task is in a sleep state but the task is in an active state in view of another core that is processing the task. Because the task is actually being processed by one of the multiple cores, the task is in an active state from the view of the multi-core apparatus.

The active state is a state in which a task is processed by a core. As aforementioned in the description of the sleep state, whether a task is in a sleep state or an active state can be determined depending on an individual core.

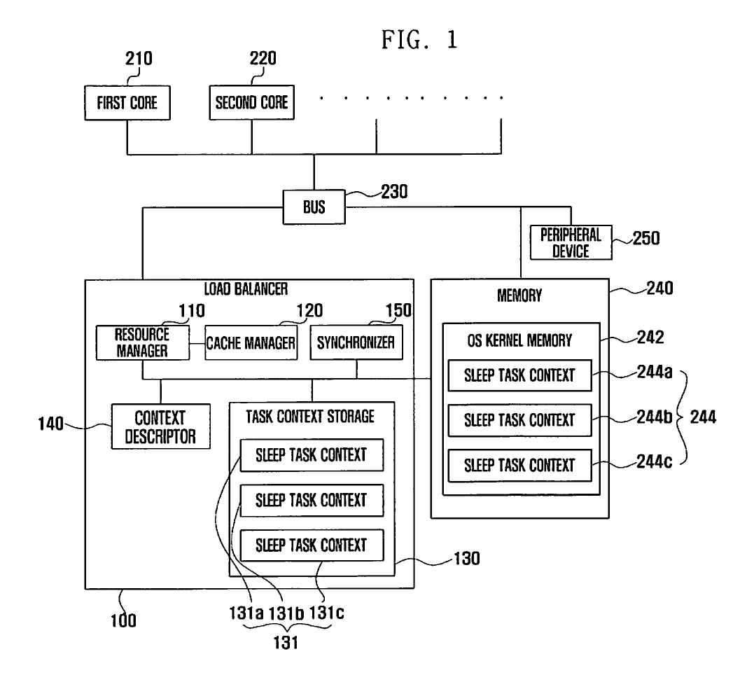

FIG. 1 is a diagram illustrating a multi-core apparatus according to an embodiment of the present invention.

Referring to FIG. 1, a multi-core apparatus includes a load balancer 100, a first core 210, a second core 220, a bus 230, a memory 240, and a peripheral device 250.

The bus 230 establishes an electrical pass for exchanging information and signals between the cores 210 and 220 and the other function blocks, i.e., the load balancer 100, the memory 240, and the peripheral device 250.

The first and second cores 210 and 220 are responsible for processing tasks.

The peripheral device 250 can include Input/Output (I/O) devices and storage devices. Although the memory 240 is generally included in the peripheral device 250, for greater ease of description, it is illustrated as a separate function block in FIG. 1.

The memory 240 stores task-specific data and other data. The memory 240 includes an OS kernel memory 242 that stores a sleep task context 244 that is not yet stored in a task context storage 130 or should not be stored in the task context storage 130.

More specifically, according to an embodiment of the present invention, the first core 210 transmits a save request to the load balancer 100 to request storing a context of a task switched to a sleep mode, when a context switch has occurred, and transmits a context request to the load balancer 100 to request the previously saved context of the task switched to an active state.

The load balancer 100 saves the context of the task switched to the sleep state in response to the save request and provides the previously saved context of the task switched to the active state to the first core 210, in response to the context request transmitted by the first core 210. The first core 210 restarts the process of the task that was switched to the active state based on the context provided by the load balancer 100.

The load balancer 100 assigns the task in the active state to the second core 220. The load balancer 100 controls such that at least one task that has been switched to the sleep state in the first core 210 is processed by the second core 220.

The second core 220 processes the task assigned by the load balancer 100.

The first core 210 selects the task to process and performs context switching according to a command of the OS. The first core 210 also requests the load balancer 100 to save the context and to provide the saved context.

The first core 210 operates in an active manner in relation with the load balancer 100. That is, the first core selects the task and then requests the load balancer 100 for details of the selected task.

The second core 220 operates in a passive manner in relation with the load balancer 100. That is, the second core 220 processes the task assigned by the load balancer 100.

In consideration of the activeness of the first core 210 and the passiveness of the second core 220, the first and second cores 210 and 220 can be referred to as active and passive cores, respectively.

Additionally, although FIG. 1 illustrates one second core 220, it is also possible to have more second cores 220 in the multi-core apparatus. When multiple second cores exist, the load balancer 100 can assign the tasks such that the load is distributed to the second cores.

Although the context switch occurs passively in the second core 220 with the involvement of the load balancer 100, the second core 200 can request that the load balancer 100 save the context of the task switched to the sleep state, when the context switch has occurred and uses the context provided by the load balancer 100 to restart the task switched to the active state.

The load balancer 100 saves the context of the task and cache data in association with the context. When providing the saved context of the task to the first core 210 or the second core 220, the load balancer 100 also provides the cache data along with the context.

By simultaneously saving and providing the task context and the cache data, the cache is recovered along with the task such that it is possible to process the task more efficiently after a restart of the task.

In accordance with an embodiment of the present invention, the load balancer 100 includes a resource manager 100, a cache manager 120, a task context storage 130, a context descriptor 140, and synchronizer 150.

The task context storage 130 saves the context of the task switched to the sleep state at the first core 210 or the second core 220, i.e., the sleep state task context 131, and provides the first core 210 or the second core 220 with the saved context of the task switched to the active state at the first core 210 or the second core 220.

If the task is switched to the sleep state at the first core 210, the first core 210 requests that the task context storage 130 save the context of the task switched to the sleep state. That is, the task context storage 130 stores the context 131 of task switched to the sleep mode.

Once the first core 210 or the second core 220 restarts processing the task switched to the active state, the saved context of the corresponding task is provided to the first core 210 or the second core 220 that processes the task.

The task context storage 130 saves the sleep state task contexts 131a, 131b, and 131c. It is assumed that the task context storage 130 is faster than the memory 240 in access speed. In this case, the burden of the context switching can be reduced. Because storage having fast access speed is limited in capacity from the viewpoint of cost efficiency, it may be preferable to maintain the task context storage 130 in an appropriate size and store the data exceeding the capacity of the task context storage 130 in the OS kernel memory 242 of the memory 240. It also may be preferable to store the sleep state contexts 131a, 131b, and 131c of the frequently processed task, important task, high priority task, and parallel processing-capable task within the task context storage 130 and to store the sleep state contexts 244a, 244b, and 244c of the relatively less frequently processed task, less important task, low priority task, and parallel processing-incapable task within the OS kernel memory 242.

The resource manager 110 assigns the task in the active state to the second core 220. The resource manage 110 assigns the active state task to the second core 220 in consideration of the priority policy and other policies. A task that is processed in an active state by the first core 210 cannot be assigned to the second core 220. A task can be divided into a plurality of sub-tasks such that the sub-tasks are processed in active state by multiple cores.

The load balancer 100 further includes a cache manager 120 for utilizing the cache more efficiently.

If a task is switched to the sleep state, the cache manager 120 stores the context of the task along with the cache data related to the task. If the task is switched to the sleep state according to the determination of the first core 210 or the resource manager 110, the context of the task is saved in the task context storage 130 and the cache data of the task is saved in the cache manager 120 in association with the context of the task.

If the sleep state task is switched to the active state, the cache manager 120 provides the cache data stored in association with the context of the task. If the task is switched to the active state according to the determination of the first core 210 or the resource manage 110, the context of the task is provided to the core to process the task and the cache data stored in association with the context of the task is also provided to the core to process the task.

When performing context switching, the first core 210 requests the task context storage 130 to provide the context of a task. If the task requested by the first core 210 is not active at any of the cores, the task context requested by the first core 210 is stored in the task context storage 130 or the OS kernel memory 242. In this case, the first core 210 can receive the context provided by the task context storage 130 or the OS kernel memory 242.

It is possible that a task requested by the first core 210 is being processed by the second core 220. In this case, the resource manager 110 controls the second core 220 to stop processing the task. Also, the task context storage 130 receives the context of the corresponding task from the second core 220 and sends the context to the first core 210. The cache manager 120 receives the cache data of the corresponding task from the second core 220 and provides the cache data to the first core 210.

In accordance with an alternate embodiment of the present invention, the cache manager 120 can be omitted.

The context descriptor 140 provides the format of the sleep task context 131 and 244 to be stored in the task context storage 130. The context storage format can include the data structure and information about the data values. The context storage format can be modified depending on the OS or system, and the context descriptor 140 can provide multiple context storage formats for the system operating with multiple OSs.

The synchronizer 150 is responsible for synchronization between cores. The synchronizer 150 can include semaphore. When the synchronizer 150 is not included in the load balancer 100, synchronization can be achieved using other synchronization-supporting device included in the multi-core apparatus.

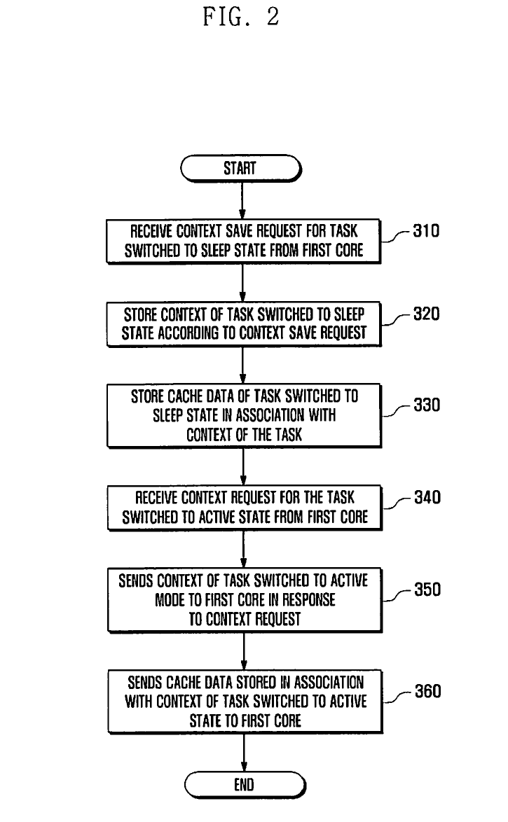

FIG. 2 is a flowchart illustrating a load balancing method of a multi-core apparatus according to an embodiment of the present invention. For ease of description, the procedure illustrated in FIG. 2 is described below as being performed by the load balancer 100, as illustrated FIG. 1, by way of example.

As described above, the load balancer 100 stores and provides a context and cache data in response to a request from the first core 210. When the first core 210 performs a context switch according to a policy of an OS, a load balancer performs the procedure illustrated FIG. 2. The first core 210 can perform the context switch by itself according to the policy of the OS and send the load balancer 100 the save request including the context and cache data of the task switched to the sleep state.

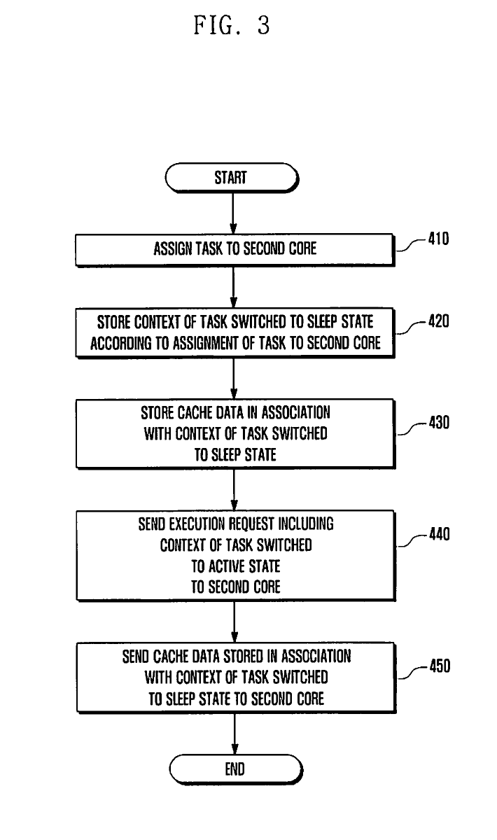

Referring to FIG. 3, the task context storage 130 of the load balancer 100 receives a save request including a context and cache data of a task switched to a sleep state in step 310.

In accordance with an embodiment of the present invention, when there is no cache manager included in the load balancer 100, the save request only includes the context of the task without cache data. In this case, steps 330 and 360 can be omitted.

Upon receipt of the save request transmitted by first core 210, the task context storage 130 of the load balancer 100 stores the context of the task which is contained in the save request in step 320.

In step 330, the cache manager 120 of the load balancer 100 stores the cache data included in the save request in association with the context of the task (330).

After storing the cache data of the task, in step 340, the task context storage 130 of the load balancer 100 receives, from the first core, a context request requesting the context of the task switched to the activate state. Because the first core 210 performs the context switch, there can be a task switched to the active state as well as the task switched to the sleep state. The first core 210 sends the context request to the load balancer 100, requesting the context of the task switched to the active state.

Upon receipt of the context request, in step 350, the task context storage 130 of the load balancer 100 provides the first core 210 with the context of the task switched to the active state, in response to the context request. The context of the task switched to the active state can be stored in the task context storage 130 or an OS kernel memory 242. In accordance with an embodiment of the present invention, the context of the sleep state task of the second core 220 can be stored in the task context storage 130 or the OS kernel memory 242.

In step 360, the cache manager 120 of the load balancer 100 provides the first core 210 with the cache data that is stored in association with the context of the task switched to the active state.

FIG. 3 is a flowchart illustrating a load balancing method of a multi-core apparatus according to another embodiment of the present invention.

Referring to FIG. 3, in step 410, a resource manager 110 of the load balancer 100 assigns a task to the second core 220).

As described above, there can be one or more second cores provided in the multi-core apparatus. The resource manager 110 assigns the task to be processed in an active state to the second core 220 in consideration of the priority policy and other status. The task assignment can be performed periodically, when change is detected or there is no need to maintain the active state any more, before the end of the ongoing task, or when a request is received.

After assigning the task to the second core 220, a task context storage 130 of the load balancer 100 receives the context of the task switched to the sleep state from the second core 220 and stores the received context in step 420. The context storage process can be performed in response to the request transmitted by the second core 220 or the resource manager, 110 or according to its own determination of the task context storage 130.

In step 430, a cache manager 120 of the load balancer 100 stores the cache data of the task switched to the sleep state in association with the context of the task. By storing the cache data in association with the context of the task, it is possible to efficiently restart the task by restoring context and cache data.

After storing the cache data, in step 440, the task context storage 130 of the load balancer 100 assigns a task to the second core 220 and sends the second core 220 an execution request including the context of the task switched to the active state, i.e., the task assigned to the second core 220 (440). The context stored in steps 420 or 320 can be provided to the core, which restarts the task in step 440.

In step 450, the cache manager 120 of the load balancer 100 provides the second core 220 with the cache data stored in association with the context of the task switched to the active state. In accordance with an embodiment of the present invention in which the load balancer includes the cache manager 120, the execution request can include the context and cache data of the task assigned to the second core.

The cache data stored in steps 430 or 330 can be provided along with the context of the task to be restarted so as to facilitate the restart of the task.

Steps 430 and 450 are performed when the load balancer includes a cache manager 120, but can be omitted when the load balancer 100 has no cache manager 120. This means that only the context of the task is provided.

The procedures illustrated in FIGS. 2 and 3 can be performed in parallel.

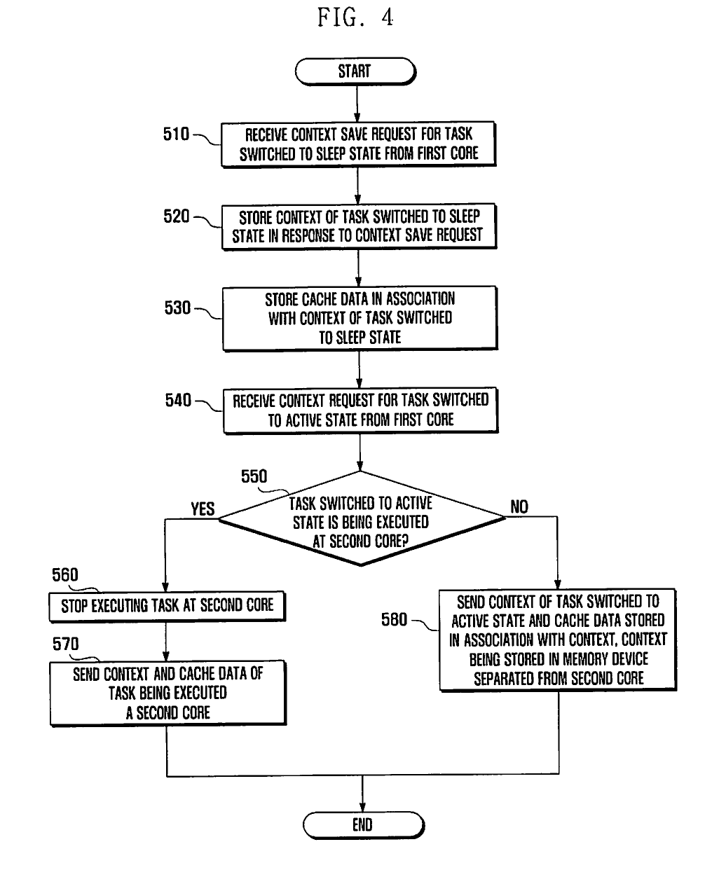

FIG. 4 is a flowchart illustrating a load balancing method of a multi-core apparatus according to another embodiment of the present invention. For ease of description, the procedure illustrated in FIG. 4 is described below as being performed by the load balancer 100, as illustrated FIG. 1, by way of example.

More specifically, the procedure illustrated FIG. 4 is performed by the load balancer 100 when the first core 210 performs context switch. The first core 210 performs context switch by itself according to the policy of the OS and sends the load balancer 100 a save request including the context and cache data of the task switched to the sleep state.

Referring to FIG. 4, steps 510 to 530 illustrate a process for storing a context of a task switched to a sleep state and cache data associated with the context. However, because steps 510 to 530 of FIG. 4 are identical with steps 310 of FIG. 2, a repetitive detailed description of steps 510 to 530 will not be provided herein.

In step 540, the task context storage 130 of the load balancer 100 receives the context request to request for the context of the task switched to the active state that is transmitted by the first core 210.

In step 550, the task context storage 130 of the load balancer 100 determines whether the task switched to the active state is being processed in the second core 220 (or in one of the second cores, if multiple second cores exist). Accordingly, at least one of the task context storage 130, the resource manager 110, a component of the load balancer 100, and a function block of the multi-core apparatus maintains a table for managing the tasks being processed by the individual cores. The table is updated whenever the context switch is performed by any of the cores to maintain the information up to date.

If the task switched to the active state is being processed in the second core 220, the resource manager 110 stops processing the task corresponding to the context requested by the first core 210 at the second core in step 560. This is for assigning the task requested by the first core 210 to the first core 210. The second core 220 at which the task requested by the first core 210 is stopped is assigned another task or stays in the sleep mode without processing other task.

In step 570, the load balancer 100 sends the first core 210 the context requested by the first core 210 and the cache data associated with the context. The context switch can be performed efficiently by switching the task between cores by maintaining the process of the task as long as possible.

If the task switched to the active state is not being processed in the second core 220, in step 580, the resource manager 110 sends the first core 210 the sleep state task context 131 and 244 and stored in other memory device, e.g. task context storage 130 or OS kernel memory 242, and the cache data stored in the cache manager 120 in association with the corresponding context.

The procedures illustrated in FIGS. 3 and 4 can be performed in parallel.

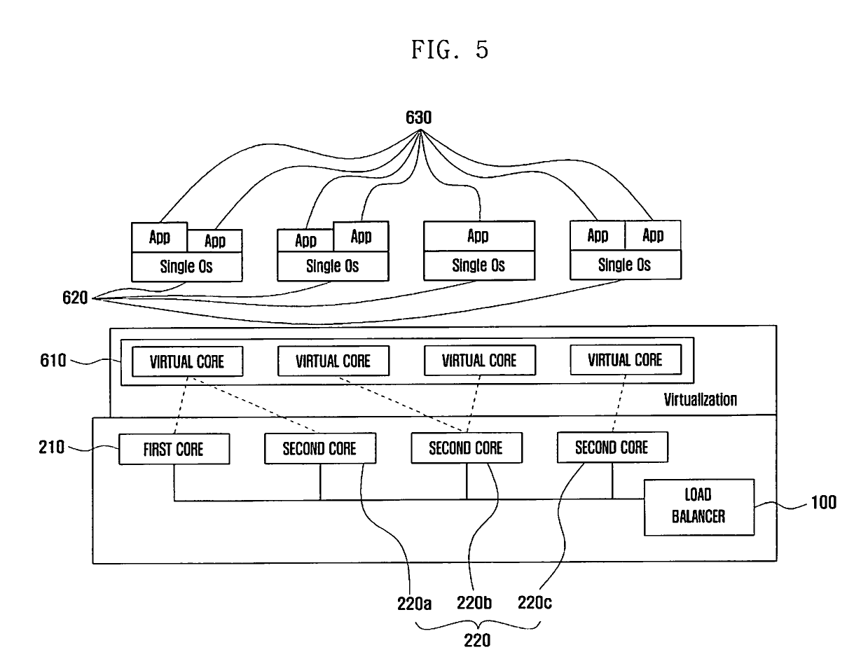

FIG. 5 is a diagram illustrating a multi-core system based on core virtualization according to an embodiment of the present invention.

Referring to FIG. 5, the multi-core system uses single core OSs 620 rather than an OS developed for multi-core system. Each single core OS 620 is provided with applications installed therein.

The single core OS 620 is running on the virtual cores 610, and the virtual cores 610 can use the multiple cores 210 and 220 efficiently with the load balancer 100. That is, the virtual cores 610 requests a first core 210 to execute the instruction and receives a response such that the single core OS 620 running on a single core can be used in the system illustrated in FIG. 5. However, because the task switched to the sleep mode at the first core 210 is assigned to be efficiently executed at the second core 220 by the load balancer 100, the single core OS can be used on all of the cores.

In view of each virtual core, the first cores 210, i.e., the cores transmitting the instructions and receiving the responses, are not needed to be identical with each other. That is, the first core is the core denoted by reference number 210 in view of a virtual core, however, it can be one of the cores denoted by reference numbers 220a, 220b, and 220c in view of another virtual core.

By using such virtualization technique, it is possible to implement an efficient virtualization and multi-core system with the use of single core OS.

By implementing the multi-core system with a conventional single core OS, it is possible to reduce the cost required for the multi-core dedicated OS development.

As described above, the multi-core apparatus and load balancing method of the multi-core apparatus according to an embodiment of the present invention is capable of balancing a load between multiple cores by storing contexts of tasks and providing the stored contexts when required.

Also, the multi-core apparatus and load balancing method of the multi-core apparatus according to an embodiment of the present invention advantageously uses virtual cores efficiently by using an improved task context record and provision mechanism.

Additionally, a multi-core apparatus and load balancing method of a multi-core apparatus according to an embodiment of the present invention is capable of saving costs required for developing a multi-core operating system by using an improved task context record and provision mechanism.

It will be appreciated by those skilled in the art that the conception and disclosed embodiments may be readily utilized as a basis for modifying or designing other structures for carrying out the same purposes of the present invention. Therefore, the foregoing is considered as illustrative only of the principles of the present invention. Further, because numerous modifications and changes will readily occur to those skilled in the art, it is not desired to limit the present invention to the exact construction and operation illustrated and described in the present application, and accordingly, all suitable modifications and equivalents may be resorted to, falling within the scope of the present invention.

Although certain embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims and their equivalents.

What is claimed is:

1. A multi-core apparatus comprising:
a first core that sends a save request including a context, when a task is switched from an active state to a sleep state, the context including information on a state of the task;
a second core that receives an execution request and executes a task corresponding to a context included in the execution request; and
a load balancer that receives the save request transmitted by the first core, saves the context included in the save request, assigns a saved context to the second core, and sends, to the second core, the execution request including the context assigned to the second core.

2. The multi-core apparatus of claim 1, wherein the save request further includes cache data of the task switched from the active state to the sleep state, and the execution request from the load balancer further includes cache data of the task corresponding to the context included in the execution request,
wherein the second core stores the cache data included in the execution request into a cache of the second core, and
wherein the load balancer stores the context and the cache data included in the save request in association with each other, and sends, to the second core, the execution request including the context assigned to the second core and the cache data stored in association with the context.

3. The multi-core apparatus of claim 1, wherein the first core sends, to the load balancer, a context request requesting a context corresponding to a task to be switched from the sleep state to the active state, when the task is switched from the sleep state to the active state, and
wherein the load balancer receives the context request and sends, to the first core, the context indicated by the context request.

4. The multi-core apparatus of claim 3, wherein the load balancer controls the second core to stop executing the task, when the task corresponding to the context indicated by the context request is being executed in the second core.

5. The multi-core apparatus of claim 4, wherein the load balancer sends the first core the context indicated by the context request, when the task corresponding to the context indicated by the context request is being executed in the second core.

6. The multi-core apparatus of claim 5, wherein the load balancer sends, to the first core, cache data received from the second core in response to the context request, when the task corresponding to the context indicated by the context request is being executed in the second core.

7. The multi-core apparatus of claim 1, wherein the load balancer stores the context included in the save request into at least one of a task context storage and an Operating System (OS) kernel memory.

8. The multi-core apparatus of claim 7, wherein the load balancer stores contexts of frequently executed tasks in the task context storage and contexts of less frequently executed tasks in the OS kernel memory.

9. The multi-core apparatus of claim 1, further comprising at least one virtual core for executing applications,
wherein the load balancer assigns tasks used for the applications of the at least one virtual core to the first core and the second core.

10. A load balancing method of a multi-core apparatus, comprising:
receiving, from a first core, a save request, the save request including a context of a task that is switched from an active state to a sleep state;
storing the context included in the save request;
assigning a stored context to a second core; and
transmitting, to the second core, an execution request including the context assigned to the second core.

11. The load balancing method of claim 10, wherein the save request further includes cache data of the task,
wherein storing the context included in the save request comprises saving the context and the cache data included in the save request in association with each other, and
wherein assigning the stored context comprises sending the execution request including cache data stored in association with the context assigned to the second core,
further comprising storing, by the second core, the cache data included in the execution request into a cache of the second core.

12. The load balancing method of claim 10, further comprising:
receiving, a context request requesting a context of a task, when the task is switched from the sleep state to the active state in the first core; and
sending, to the first core, the context indicated by the context request.

13. The load balancing method of claim 12, further comprising controlling the second core to stop executing the task, when the task corresponding to the context indicated by the context request is being executed in the second core.

14. The load balancing method of claim 13, further comprising sending, to the first core, the context indicated by the context request, when the task corresponding to the context indicated by the context request is being executed in the second core.

15. The load balancing method of claim 14, further comprising sending, to the first core, cache data received from the second core in response to the context request if the task corresponding to the context indicated by the context request is being executed in the second core.

16. The load balancing method of claim 10, wherein storing the context comprises saving the context included in the save request into at least one of a task context storage and an Operating System (OS) kernel memory.

17. The load balancing method of claim 16, wherein storing the context further comprises:
saving contexts of frequently executed tasks in the task context storage; and
saving contexts of less frequently executed tasks in the OS kernel memory.

18. The load balancing method of claim 10, further comprising assigning tasks used for applications of at least one virtual core to the first core and the second core.
